(19) United States
(12) Patent Application Publication
(10) Pub. No.: US 2017/0274518 A1
(43) Pub. Date: Sep. 28, 2017

(54) AIR HAMMER ATTACHMENT

(71) Applicant: Mark Steffenhagen, DeWitt, IA (US)

(72) Inventor: Mark Steffenhagen, DeWitt, IA (US)

(21) Appl. No.: 15/081,996

(22) Filed: Mar. 28, 2016

(51) Int. Cl. B25D 17/00; B25D 9/00

(52) U.S. Cl. CPC B25D 17/005; B25D 9/00; B25D 2250/171; B25D 2250/181

(57) ABSTRACT

An air hammer attachment having a support device extending between a first end and a second end. The first end has a threaded shaft and bolt. The second end having an inwardly extending rod and threaded bolt.

### BACKGROUND OF THE INVENTION

The present invention is directed to an attachment for an air hammer and, more specifically, an attachment that converts an air hammer into a slide hammer.

Air hammers and slide hammers are well-known in the art. Both devices are expensive and perform different functions. An air hammer exerts an outward pushing pneumatic force and a slide hammer exists a pulling force. While both are useful, for convenience and to reduce expense, a need exists in the art where a device is configured to perform both functions.

Therefore, an objective of the present invention is to provide an attachment for an air hammer that provides a pulling function.

Another objective of the present invention is to provide an attachment for an air hammer that eliminates the need for a slide hammer. These and other objectives will be apparent to one of ordinary skill in the art based upon the following written description, drawings and claims.

### SUMMARY OF THE INVENTION

An attachment for an air hammer having a support device extending between a first end and a second end. The first end having a threaded shaft and nut. The support device preferably having a pair of spaced rods welded to the first and the second end. The second end has a threaded nut and a rod that extends inwardly and is configured to be received by an air hammer.

### BRIEF DESCRIPTION OF THE DRAWINGS

FIG. 1 is a top perspective view of an attachment for an air hammer; and

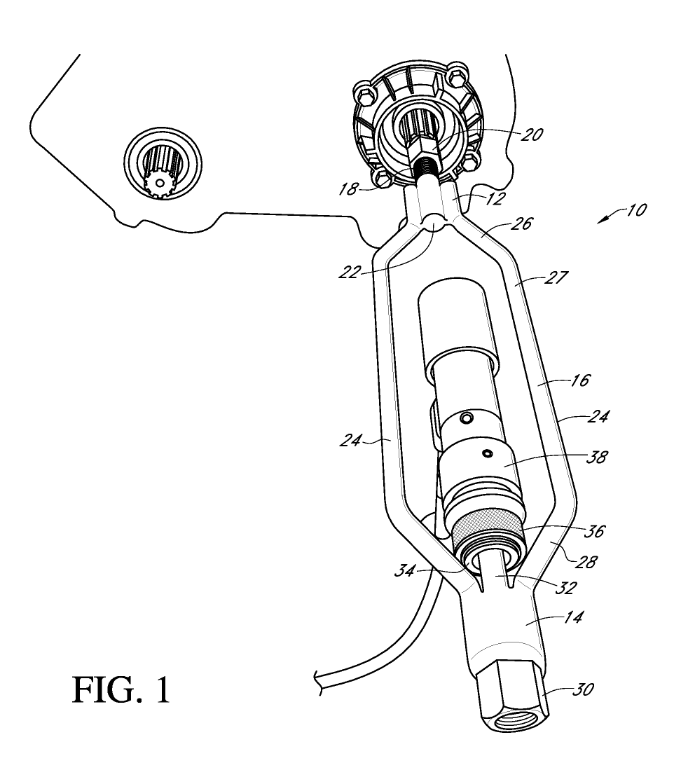

FIG. 2 is a side perspective view of an attachment for an air hammer.

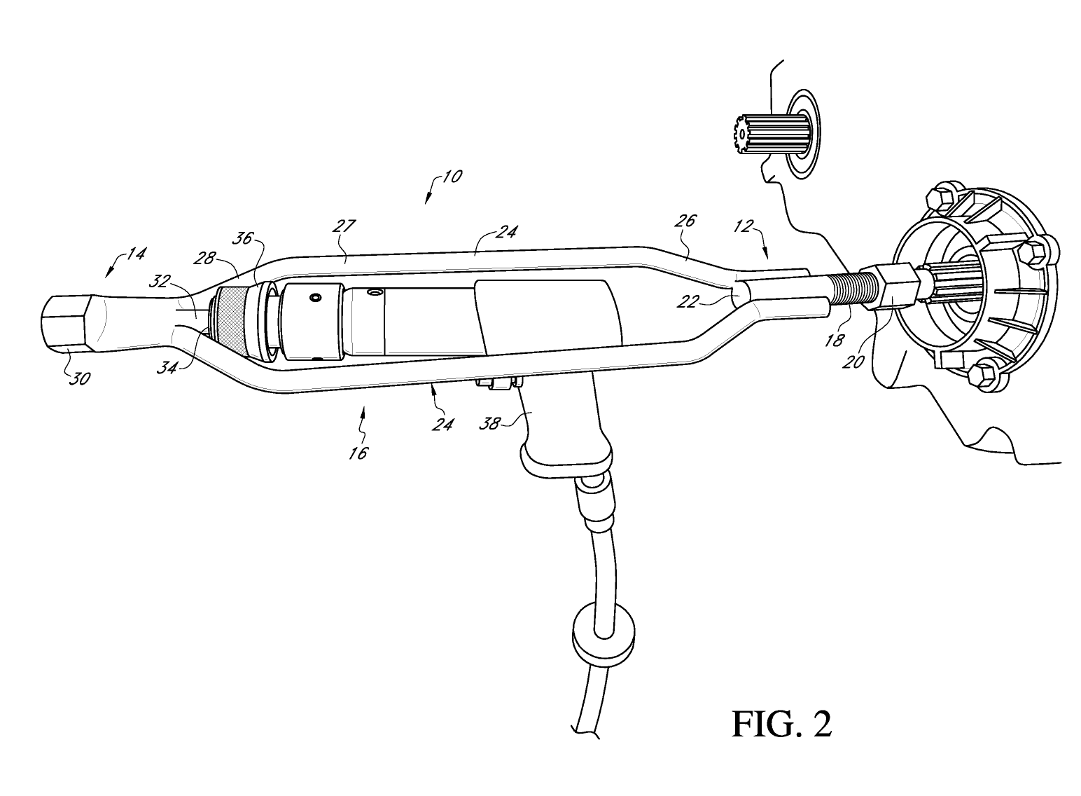

### DETAILED DESCRIPTION OF THE PREFERRED EMBODIMENT

Referring to the figures, an air hammer attachment 10 has a first end 12 and a second end 14 separated by a support device 16. The first end 12 has a threaded shaft or bolt 18 with a nut 20 threadably connected to the shaft 18. The support device 16 is connected to an inward end 22 of shaft 18. The support device 16 is of any size and shape, and, in a preferred embodiment, includes a pair of spaced longitudinally extending rods 24. The rods 24 have a first section 26 that angles outwardly from the axis of shaft 18, a second longitudinal section 27, and a third section 28 that angles inwardly toward the second end 14. The support device 16 is connected to shaft 18 in any manner and, in a preferred embodiment, the rods 24 are welded to shaft 18.

The second end 14 has a threaded nut 30 and a rod 32 that extends from the nut 30 inwardly back toward shaft 18. The support device 16 is connected to the second end 14 and, preferably, is welded to the nut 30 and rod 32. An inward end 34 of rod 32 is configured to be received within the barrel 36 of an air hammer 38. The nut 30 is configured to connect to other devices as needed.

In operation, the threaded shaft 18 and nut 20 are attached to an object 40, such as a rear axle seal, a damaged car body, or the like that needs to be pulled. The barrel 36 of air hammer 38 is placed over the inward end 34 of rod 32. Once set up, the air hammer is activated exerting pneumatic force against rod 32. The pneumatic force causes attachment 10 to push outwardly from the hammer 38 causing the first end 12 of attachment to pull against object 40.

Accordingly, an attachment for an air hammer has been disclosed that converts an air hammer into a slide hammer and at the very least meets all the stated objectives.

What is claimed is:

1. An air hammer attachment, comprising:
a support device extending between a first end and a second end;
the first end having a shaft and nut; and
the second end having an inwardly extending rod attached to an air hammer.

2. The attachment of claim 1 wherein the support device includes a pair of rods.

3. The attachment of claim 2 wherein the rods have a first section that angles outwardly from an axis of the shaft, a second section that extends longitudinally, and a third section that extends inwardly towards the second end.

4. The attachment of claim 1 wherein the support device is welded to the first and the second end.
